(19) United States
(12) Patent Application Publication
(10) Pub. No.: US 2002/0184415 A1
(43) Pub. Date: Dec. 5, 2002

(54) Health hub system and method of use

(75) Inventors: Morteza Naghavi, Housston, TX (US); Mohammad Madjid, Houston, TX (US); Parsa Mirhaji, Houston, TX (US); Reza Mohammadi, New York, NY (US); David J. Robinson, Houston, TX (US)

Correspondence Address: Gary R. Maze, Duane Morris LLP, Suite 500, One Greenway Plaza, Houston, TX, 77046, US

(73) Assignee: BOARD OF REGENTS, THE UNIVERSITY OF TEXAS SYSTEM

(21) Appl. No.: 10/157,311

(22) Filed: May 29, 2002

Related U.S. Application Data
(60) Provisional application No. 60/294,040, filed on May 29, 2001.
(60) Provisional application No. 60/293,965, filed on May 29, 2001.
(60) Provisional application No. 60/293,964, filed on May 29, 2001.
(60) Provisional application No. 60/293,897, filed on May 29, 2001.

(51) Int. Cl. G06F 13/00

(52) U.S. Cl. 710/64

(57) ABSTRACT

A device to communicate data received from a medical device disclosed. The device comprises a hosting assembly; an input data port accessible through the hosting assembly and capable of acquiring medical data from a medical device; an output data port accessible through the hosting assembly; and a bi-directional data buffer operatively connected to the plurality of input data ports and the output data port. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### RELATION TO OTHER APPLICATIONS

The present invention claims priority from U.S. Provisional Application No. 60/294,040 filed May 29, 2001, U.S. Provisional Application No. 60/293,965 filed May 29, 2001, U.S. Provisional Application No. 60/293,964 filed May 29, 2001, and U.S. Provisional Application No. 60/293,897 filed May 29, 2001.

### BACKGROUND OF THE INVENTION

Many computer systems, including personal computers, workstations, servers, and embedded systems are designed to have multiple peripheral devices attached to the system. A typical personal computer system includes a number of peripheral devices that provide input and output (I/O) for the system. Such peripheral devices include, for example, compact disk read-only memory (CD-ROM) drives, mass storage devices such as tape drives, multimedia support devices, and the like. Additionally, computer systems often have the capability to interface with devices present in external enclosures.

Personal computers are frequently used for data acquisition from medical devices, but most of existing medical devices either do not implement data communication standards, requiring instead specific data port types as well as specific applications installed into the personal computer.

Further, personal computers often do not have sufficient or suitable data ports to connect with multiple medical devices at once.

Accordingly, in certain environments such as home environments, having more than one type of medical devices may give rise to the following problems. Every medical device may need an specially configured personal computer system. Conflicts may cause personal computers to not function properly and simultaneous data acquisition may be impossible, e.g. conflicts in interrupts, I/O ports, or DMA channels. A personal computer may not have suitable or sufficient data communication ports to communicate with more than one medical device at a time. The process of switching from one medical device to another in the same port may required extraordinary efforts or skills. The process of switching between different medical devices may be time consuming and hazardous. An upgrade or change to a medical device may require an upgrade or change to personal computer. Simultaneous data channeling, e.g. to the personal computer and a data network at once, for more than one source of data is almost impossible.

Often, data is acquired from medical devices cycles in a circuit defined and supported by a proprietary software system. These data are often not available to be used or otherwise communicated through a data network with other healthcare platforms.

Prior art solutions are focused on integrating the communication between multiple peripheral equipment with a personal computer but do not address issues concerning ongoing data, e.g. supporting channeling data directly into a data network or support buffering, display, storage, and export of the data. Typically, the prior art does not support data validation and interpretation and are highly integrated conduits.

Examples of prior art efforts to deal with these issues are disclosed in U.S. Pat. No. 6,058,441; U.S. Pat. No. 5,264,958; U.S. Pat. No. 5,933,656; U.S. patent No. JP11175206A2; U.S. Pat. No. 4,631,698; U.S. Pat. No. 4,607,170; U.S. Pat. No. 4,607,379; and U.S. Pat. No. 5,165,022.

The present invention comprises an integrated, multi-channel connector used to simultaneously channel, redirect, process, validate, store, and display a variety of medical data from multiple sources. Software drivers are available to automatically recognize and work with diverse types of medical devices connected to the present invention. The present invention can simultaneously channel outgoing acquired data to a personal computer and a data network.

### BRIEF DESCRIPTION OF THE DRAWINGS

These and other features, aspects, and advantages of the present invention will become more fully apparent from the following description, appended claims, and accompanying drawings in which:

FIG. 1 is a first plan view in partial perspective of an exemplary embodiment of a health hub;

FIG. 2 is a second plan view in partial perspective of an exemplary embodiment of a health hub;

FIG. 3 is a schematic of an exemplary system utilizing a health hub; and

FIG. 4 is flowchart of an exemplary method of using a health hub.

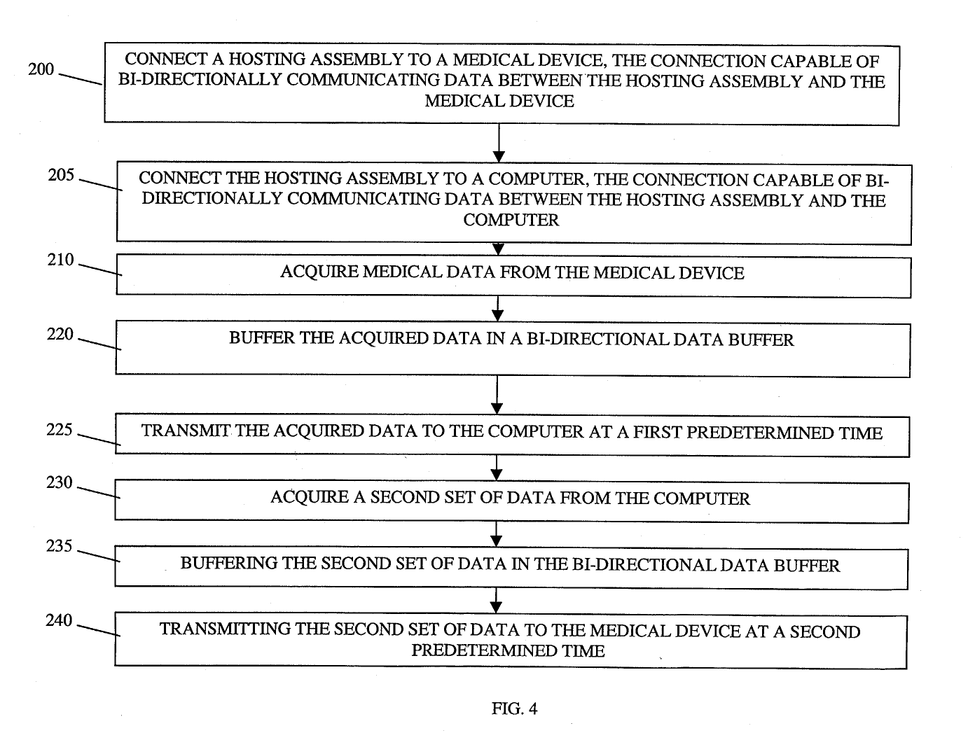

### DETAILED DESCRIPTION OF AN EXEMPLARY EMBODIMENT

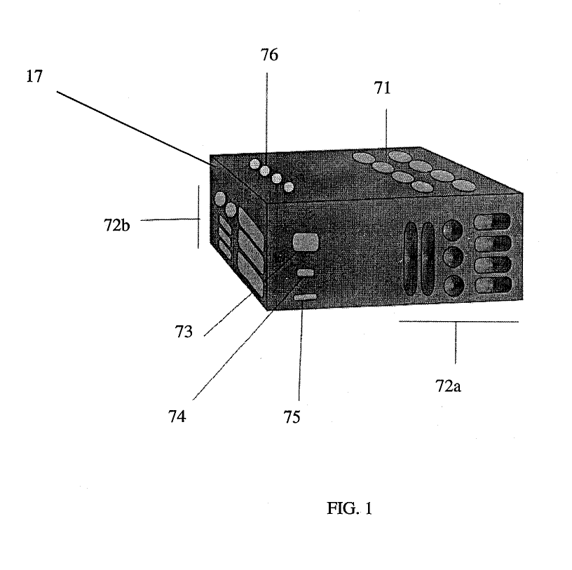

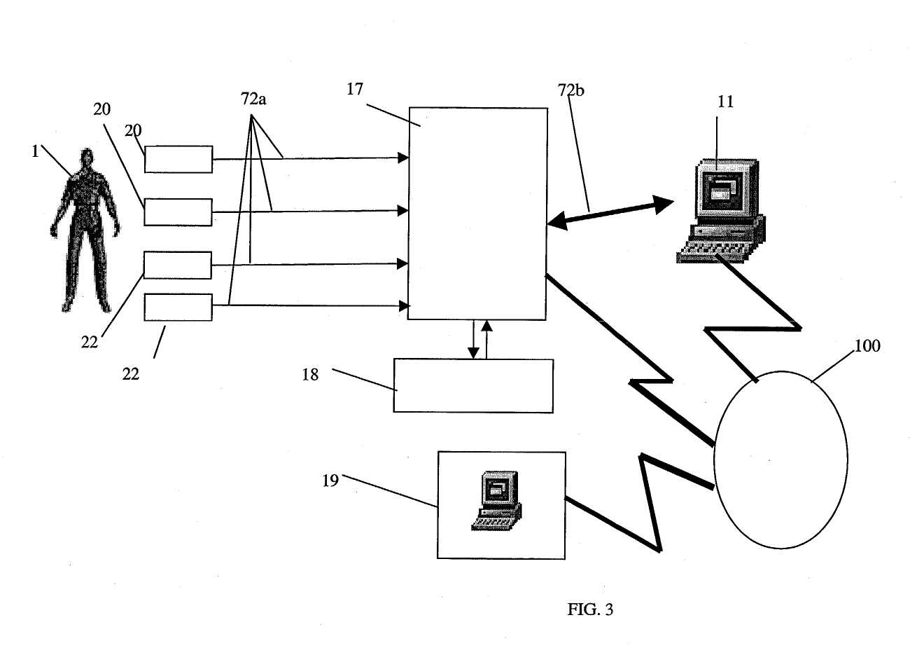

Referring now to FIG. 1 and FIG. 3, health hub 17 comprises a portable device providing one or more data communication channels, generally referred to by the numeral “70,” which can accommodate digital and/or analog data generated by medical devices 20 (FIG. 3) to personal computer 11 (FIG. 3), data network 100 (FIG. 3), or a combination thereof. As used herein, computer 11 comprises desktop computers, notebook computers, laptop computers, handheld computers such as portable digital assistants, and the like. As further used herein, data network 100 comprises the Internet, a local area network, a conventional telephone line, a cellular phone network, or the like.

Health hub 17 can also host one or more built-in medical devices 20 (FIG. 3), e.g. a retractable, low cost thermometer, a blood pressure meter, and the like, or combinations thereof. Communication between medical devices 20 and health hub 17, and between health hub 17 and personal computers 11 can be via wires or wireless.

Health hub 17 comprises one or more standard computer input data ports 72a and output data ports 72b to which medical devices 20 (FIG. 3) may be attached. As used herein, these standard ports comprise RS-232 serial ports, parallel ports, infrared ports, USB ports, PS2 ports, SCSI ports, IEEE 1934, IEEE 488 ports, HPIB ports, and the like, or combinations thereof. Health hub 17 may also comprise one or more specialized and/or dedicated ports required for certain medical devices 20. Additionally, health hub 17 may also comprise one or more data communications ports, e.g. LAN adapter 73, DSL adapter 74, modem 75, and the like, or combinations thereof.

Data can be can be directed by health hub 17 via data communication channel 70 to a standard computer data output port 72b, over data communications ports such as LAN adapter 73, and the like, or combinations thereof, including simultaneous data communications.

Buttons 71 may be present to perform predetermined functions, e.g. reset, power on, test, and the like.

One or more status indicators 76 may also be present, e.g. LED indicators to indicate functioning, condition, alarms, and the like, or combinations thereof.

In a current preferred embodiment, health hub 17 may be configured as a device capable of integration internally in computer 11 such as on a PCI or PCMIA card. In an alternative embodiment, health hub 17 may be configured as an external peripheral device to be connected to computer 11 such as by wire or wireless media.

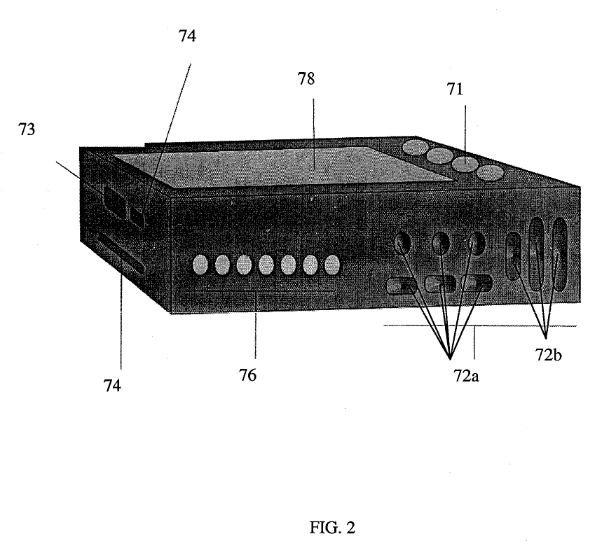

Referring now to FIG. 2, in a further alternative embodiment, health hub 17 may be configured as a stand-alone device comprising with data display 78, memory (not shown in the figures), persistent data store (not shown in the figures), and communication network channel 70, e.g. LAN adapter 73.

Referring now to FIG. 3, in a currently envisioned embodiment, health hub 17 comprises microprocessor module 18.

In the operation of an exemplary embodiment, referring still to FIG. 3, health hub 17 may be used to eliminate a need for specialized computer systems for medical devices 20 such as home-based medical devices 20 and sensors 22, to eliminate a need for different and multiple computer data ports to use such medical devices 20 at home, to bridge simultaneous streams of different data formats, e.g. analog or digital, into standard data transmission channels, and to permit integration of diverse types of medical devices 20 into a ordinary personal computer environment.

Typically, health hub 17 is connected to medical device 20 and to computer 11. The connection is capable of bi-directionally communicating data between the hosting assembly and the medical device as well as between the hosting assembly and the computer. Medical data, e.g. data from medical device 20 and/or sensor 22, are acquired from medical device 20 and buffered in a bi-directional data buffer. At a predetermined time such as upon a poll, interrupt, or timer event, health hub 17 transmits the acquired medical data to computer 11. Simultaneous or asynchronously, health hub 17 may receive data from computer 11 such as control data. These data may also be buffered in the bi-directional data buffer. At a predetermined time such as upon a poll, interrupt, or timer event, health hub 17 may transmit the second set of data to medical device 20.

Using optional microprocessor module 18, health hub 17 can process, analyze, decode, encode, filter, or make other desired changes to data acquired from medical devices 20 or from remote source 19 such as via LAN adapter 73 to data network 100 or other data communications channel 70. Input data channels 72a and output data channels 72b may be programmed remotely, such as through the data network 100, directly through a PC connection such as via LAN adapter 73, or locally in response to predetermined programming instructions executing in microprocessor module 18.

Health hub 17 can be programmed remotely, through data network 100, directly through personal computer 11, or locally from health hub 17, e.g. using control buttons 71. Additionally, multiple programs can be run simultaneously in health hub 17 using microprocessor module 18.

Health hub 17 equipped with microprocessor module 18 can monitor input data and generate alarms based on detected conditions according to preprogrammed criteria. These alarms may be transmitted to computer 11 or to another receiver such as 19 via data network 100, redirected to display 78 or a display associated with computer 11, communicated via status indicators 76 on health hub 17, or the like, or a combination thereof.

Additionally, health hub 17 can export or store predetermined data to fixed or removable persistent data store media (not shown in the figures). Data may be buffered and stored using the fixed or removable persistent data store media, volatile memory, programmable electronic memory such as EEPROMs, or the like, or combinations thereof.

It will be understood that various changes in the details, materials, and arrangements of the parts which have been described and illustrated above in order to explain the nature of this invention may be made by those skilled in the art without departing from the principle and scope of the invention as recited in the following claims.

1. A device to communicate data received from a medical device, comprising:
a. a hosting assembly;
b. an input data port accessible through the hosting assembly and capable of acquiring medical data from a medical device;
c. an output data port accessible through the hosting assembly; and
d. a bi-directional data buffer operatively connected to the plurality of input data ports and the output data port.

2. A method of communicating received from a medical device, comprising:
a. connecting a hosting assembly to a medical device, the connection capable of bi-directionally communicating data between the hosting assembly and the medical device;
b. connecting the hosting assembly to a computer, the connection capable of bi-directionally communicating data between the hosting assembly and the computer;
c. acquiring medical data from the medical device;
d. buffering the acquired data in a bi-directional data buffer;
e. transmitting the acquired data to the computer at a first predetermined time;
f. acquiring a second set of data from the computer;
g. buffering the second set of data in the bi-directional data buffer; and
h. transmitting the second set of data to the medical device at a second predetermined time.
